(19) United States
(12) Patent Application Publication
(10) Pub. No.: US 2016/0041749 A1
(43) Pub. Date: Feb. 11, 2016

(54) OPERATING METHOD FOR USER INTERFACE

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: TE-JIA LIU, Shenzhen (CN); CHIH-SAN CHIANG, New Taipei (TW); HAI-SEN LIANG, Shenzhen (CN)

(21) Appl. No.: 14/587,133

(22) Filed: Dec. 31, 2014

(30) Foreign Application Priority Data
Aug. 11, 2014 (CN) 201410391149.7

(51) Int. Cl. G06F 3/0488; G06F 3/0485; G06F 3/041; G06F 3/0484

(52) U.S. Cl. CPC G06F 3/04883; G06F 3/04845; G06F 3/0485; G06F 3/0412; G06F 2203/04806

(57) ABSTRACT

An operating method of a user interface includes the following blocks. A slide area and a zoom area are defined on a touch screen. The user interface is displayed on the touch screen. A slide gesture is detected on the touch screen. A starting point and an extending direction of the slide gesture are determined on the touch screen. The slide operation or a zoom operation is exerted to the user interface according to the starting point and the extending direction of the slide gesture. The user interface slides along the extending direction of the slide gesture when the starting point is located in the slide area. The user interface zooms when the starting point is located in the zoom area.

### CROSS-REFERENCE TO RELATED APPLICATIONS

This application claims priority to Chinese Patent Application No. 201410391149.7 filed on Aug. 11, 2014, the contents of which are incorporated by reference herein.

### FIELD

The subject matter herein generally relates to an operating method of a user interface.

### BACKGROUND

Electronic devices with touch-screens and user interfaces running on such devices may have slide operation or zoom operations to facilitate browsing and employing applications.

### BRIEF DESCRIPTION OF THE DRAWINGS

Implementations of the present technology will now be described, by way of example only, with reference to the attached figures.

FIG. 1 is a diagrammatic view of an embodiment of an electronic device.

FIG. 2 is a diagrammatic view of a user interface of the electronic device of FIG. 1.

FIG. 3 is a diagrammatic view of a plurality of desktops of the electronic device of FIG. 1.

FIG. 4 is a diagrammatic view of a user interface of an electronic device of another embodiment.

FIG. 5 is a flowchart of an operation method of a user interface of one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

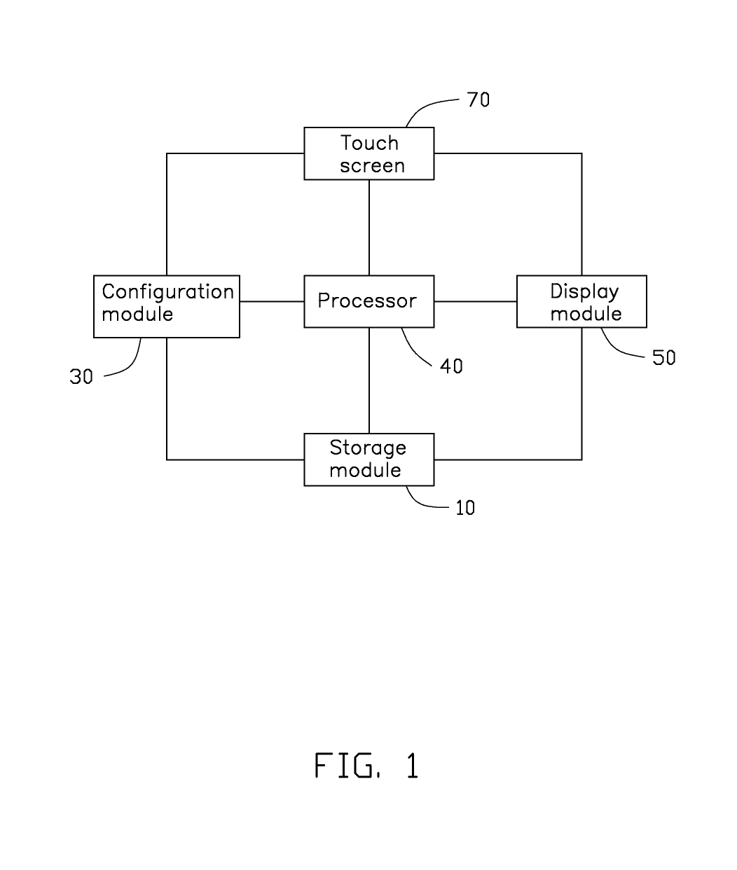

FIG. 1 illustrates a diagrammatic view of an electronic device in one embodiment. The electronic device can be a server, a laptop computer, a tablet computer, an all-in-one computer, or a smart phone. The electronic device includes a processor 40, a configuration module 30, a storage module 10 (e.g., memory), a display module 50, and a touch screen 70. It should be appreciated that the electronic device is only one example, and that the electronic device can have more or fewer components than shown, it can combine two or more components, or it can have a different configuration or arrangement of the components. The various components shown in FIG. 1 can be implemented in hardware, software or a combination of both hardware and software, including one or more signal processors and/or application-specific integrated circuits.

The memory 10 can include a high-speed random access memory, and can include non-volatile memory, such as one or more magnetic disk storage devices, optical disk storage devices, flash memory devices, or other non-volatile solid state storage devices. The memory 10 can optionally include one or more storage devices remotely located from the processor 40. All access to the memory 10 by other components of the electronic device, such as the processor 40, can be controlled by a memory controller. The one or more processors 40 can run or execute various software programs and/or sets of instructions stored in the memory 10 to perform various functions for the electronic device and to process data.

The touch screen 70 provides an input interface and an output interface between the electronic device and a user. The touch screen 70 can include a touch-sensitive surface that accepts input from the user based on physical contact and can display visual output to the user. The visual output can include graphics, text, icons, video, and any combination thereof. In some embodiments, some or all of the visual outputs can correspond to, or represent, user-interface objects. The touch screen 70 detects contact (and any motion or breaking of the contact) and converts the detected contact into an interaction with user-interface objects (e.g., one or more soft keys, icons, web pages or images) that are displayed on the touch screen 70. In one embodiment, a user can contact with a touch screen 70 with a finger.

The touch screen 70 can use liquid crystal display (LCD) technology, or a light emitting polymer display (LPD) technology, although other display technologies can be used in other embodiments. The touch screen 70 can detect contact and any motion or breakage thereof using any of a plurality of touch sensing technologies now known or later to be developed, including but not limited to capacitive, resistive, infrared, and surface acoustic wave technologies, as well as other proximity sensor arrays or other elements for determining one or more points of contact with a touch screen 70. The user can make contact with the touch screen 70 using any suitable object or appendage, such as a stylus or a finger. In some embodiments, the user interface is designed to work primarily with fingertip contact and motions, which are less precise than stylus-based input due to the larger area of surface contact of a finger on the touch-screen.

The display module 50 can provide a user interface, which can be displayed on the touch screen 70.

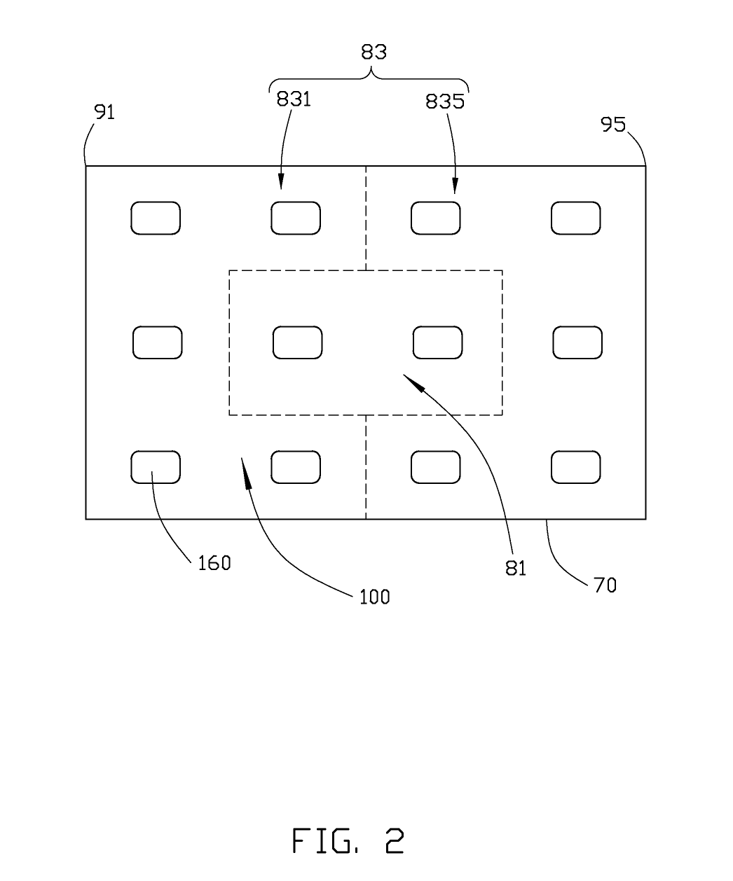

FIG. 2 is a diagrammatic view of a user interface 100 of the electronic device of FIG. 1. The user interface can include a plurality of application icons 160. A user interface 100 can be divided or partially divided to a slide area 81 and a zoom area 83. The configuration module 30 can provide configuration to define locations and areas of the zoom area 83 and the slide area 81. A first zoom point 91 is defined in a corner of the first zoom area 831. A second zoom point 95 is defined in a corner of the second zoom area 835. The first zoom point 91 and the second zoom point 95 are defined in opposite sides of the user interface 100. In one embodiment, the zoom area 83 can include a first zoom area 831 and a second zoom area 835. The slide area 81 can be defined in a central position of the zoom area 83 between the first zoom area 831 and the second zoom area 835. The slide area 81 can be substantially rectangular. The zoom area 83 can be defined around the slide area 81. The first zoom area 831 can be defined in a left side of the slide area 81. The second zoom area 835 can be defined in a right side of the slide area 81. The first zoom area 831 can be C-shaped. The first zoom area 831 and the second zoom area 835 can be substantially symmetric.

The processor 40 can determine whether a slide gesture is exerted on the touch screen 70, and can determine a position on the user interface 100 to transform the user interface 100. The touch screen 70 can determine if a gesture is a slide gesture and if the slide gesture is a signal trace slide gesture which can be exerted with one finger. The touch screen 70 can detect a starting point and an extending direction of the slide gesture. The user interface 100 can slide along the extending direction of the slide gesture when the starting point is located in the slide area 81. The user interface 100 zooms when the starting point is located in the zoom area 83. The user interface 100 can be zoomed about the first zoom point 91 when the starting point of the slide gesture is in the first zoom area 831. The user interface 100 is zoomed about the second zoom point 95 when the starting point of the slide gesture is in the second zoom area 835. The user interface 100 is zoomed out when the starting point is located in the first area and the extending direction of the slide gesture is substantially towards the first zoom point 91. The user interface 100 is zoomed in when the starting point is located in the first area and the extending direction of the slide gesture is substantially away from the first zoom point 91.

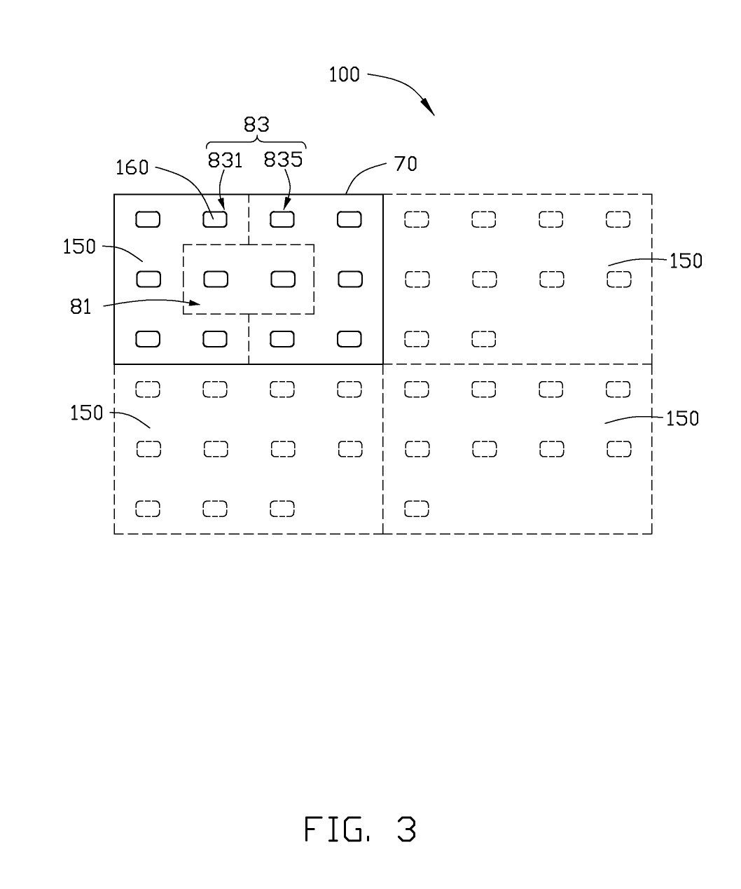

FIG. 3 is a diagrammatic view of a plurality of desktops of the electronic device of FIG. 1. A user interface can include a plurality of desktops 150. The user interface can display one of desktops on the touch screen 70 in a normal state. When the user interface is slid, the plurality of desktops 150 can be switched. When the user interface is zoomed in, one desktop 150 on the touch screen 70 is zoomed in. When the user interface is zoomed out, the plurality of desktops 160 is zoomed out and can be displayed on the touch screen 70 at the same time.

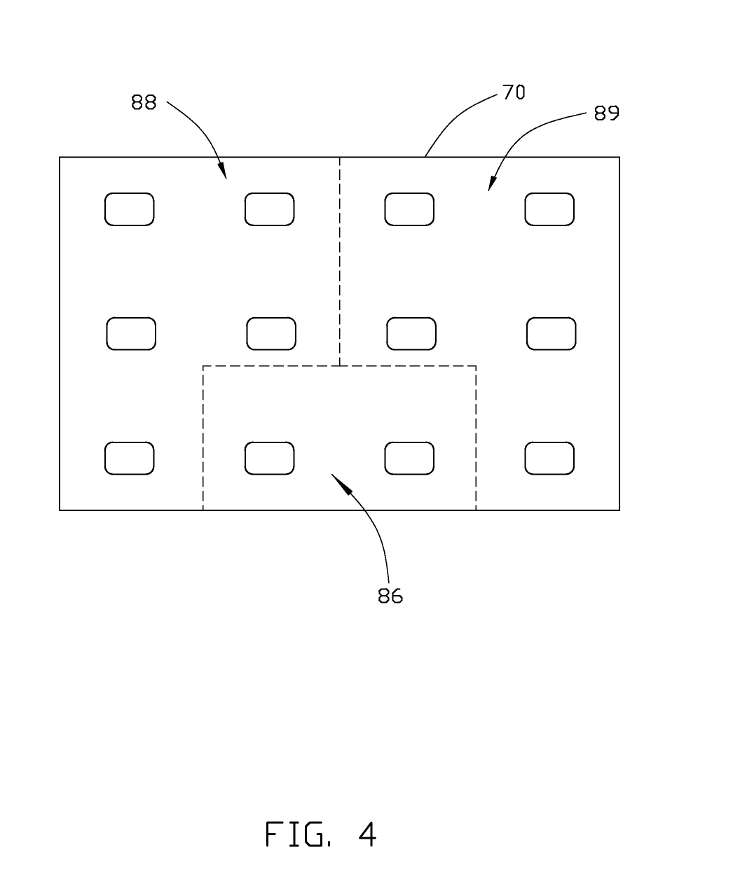

FIG. 4 is a diagrammatic view of a user interface of an electronic device of another embodiment. A user interface can include a slide area 86, a first zoom area 88 and a second zoom area 89. The slide area 86 can be located on a bottom of a touch screen. The first zoom area 88 and the second zoom area 89 can be L-shaped.

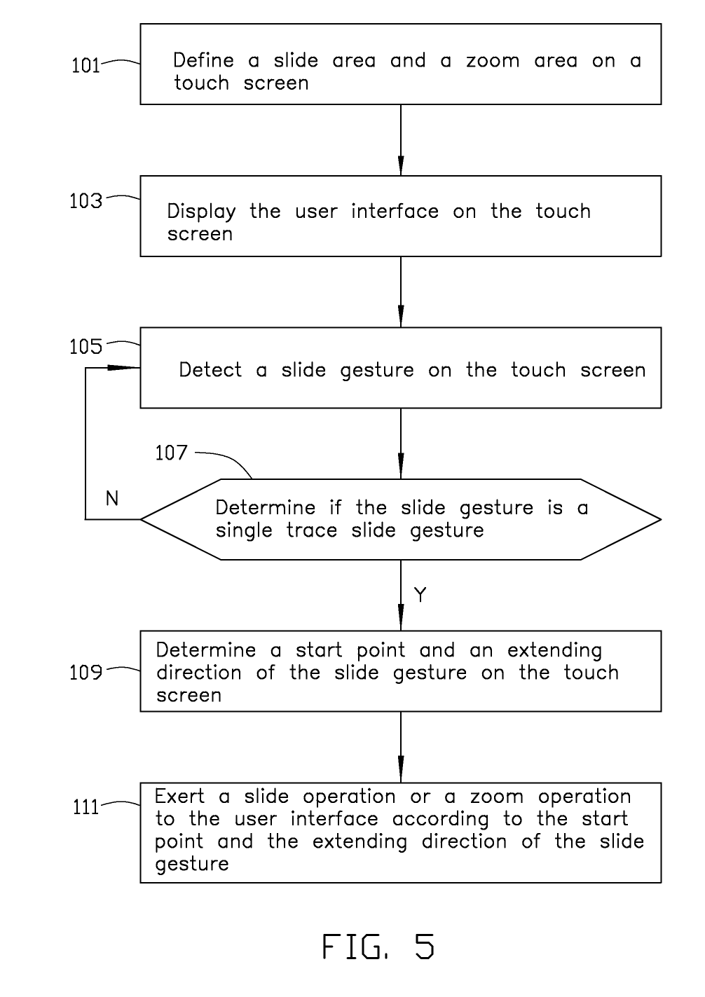

FIG. 5 illustrates an operating method of a user interface. The example method is provided by way of example, as there are a variety of ways to carry out the method. The operating method described below can be carried out using the configurations illustrated in FIG. 1, for example, and various elements of these figures are referenced in explaining the example method. Each block shown in FIG. 5 represents one or more processes, methods or subroutines, carried out in the example method. Furthermore, the illustrated order of blocks is illustrative only and the order of the blocks can change according to the present disclosure. Additional blocks can be added or fewer blocks can be utilized, without departing from this disclosure. The example method can begin at block 101. The method includes the following blocks.

At block 101, a slide area and a zoom area are defined on a touch screen.

At block 103, the user interface is displayed on the touch screen.

At block 105, a slide gesture is detected on the touch screen.

At block 107, the slide gestured is determined if the slide gesture is a single trace slide gesture.

At block 109, a starting point and an extending direction of the slide gesture can be determined on the touch screen.

At block 111, a slide operation or a zoom operation is exerted to the user interface according to the starting point and the extending direction of the slide gesture. The user interface can slide along the extending direction of the slide gesture when the starting point is located in the slide area. The user interface zooms when the starting point is located in the zoom area.

The embodiments shown and described above are only examples. Many details are often found in the art such as the other features of a method of controlling electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An operating method of a user interface comprising:
defining a slide area and a zoom area on a touch screen;
displaying the user interface on the touch screen;
detecting a slide gesture on the touch screen;
determining a starting point and an extending direction of the slide gesture on the touch screen; and
exerting a slide operation or a zoom operation to the user interface according to the starting point and the extending direction of the slide gesture;
wherein the user interface slides along the extending direction of the slide gesture when the starting point is located in the slide area, and the user interface zooms when the starting point is located in the zoom area.

2. The operating method of claim 1, further comprising determining the slide gesture as a signal trace slide gesture.

3. The operating method of claim 1, wherein the zoom area is defined around the slide area.

4. The operating method of claim 3, wherein the slide area is substantially rectangular.

5. The operating method of claim 1, wherein the zoom area is substantially C-shaped and is around the slide area.

6. The operating method of claim 1, further comprising: defining a first zoom area and a second zoom area in the zoom area; and defining a first zoom point in the first zoom area and a second zoom point in the second zoom area, wherein the user interface is zoomed about the first zoom point when the starting point of the slide gesture is in the first zoom area, and the user interface is zoomed about the second zoom point when the starting point of the slide gesture is in the second zoom area.

7. The operating method of claim 6, wherein the first zoom point and the second zoom point are defined in two opposite sides of the touch screen.

8. The operating method of claim 6, wherein the first zoom area and the second zoom area are substantially symmetric.

9. The operating method of claim 6, wherein the user interface is zoomed out when the starting point is located in the first area and the extending direction of the slide gesture is substantially towards the first zoom point.

10. The operating method of claim 6, wherein the user interface is zoomed in when the starting point is located in the first area and the extending direction of the slide gesture is substantially away from the first zoom point.

11. An electronic device comprising:
a touch screen;
a processor;
one or more modules stored in a storage module, wherein the one or more modules are configured to be executed by the processor to:
define a slide area and a zoom area on a touch screen;
display a user interface on the touch screen;
detect a slide gesture on the touch screen;
determine a starting point and an extending direction of the slide gesture on the touch screen; and
exert a slide operation or a zoom operation to the user interface according to the starting point and the extending direction of the slide gesture;
wherein the user interface slides along the extending direction of the slide gesture when the starting point is located in the slide area, and the user interface zooms when the starting point is located in the zoom area.

12. The electronic device of claim 11, wherein the one or more modules are configured to be executed by the processor to: determine the slide gesture as a signal trace slide gesture.

13. The electronic device of claim 11, wherein the zoom area is defined around the slide area.

14. The electronic device of claim 13, wherein the slide area is substantially rectangular.

15. The electronic device of claim 11, wherein the zoom area is substantially C-shaped and is around the slide area.

16. The electronic device of claim 11, wherein the one or more modules are configured to be executed by the processor to: define a first zoom area and a second zoom area in the zoom area; and define a first zoom point in the first zoom area and a second zoom point in the second zoom area, wherein the user interface is zoomed about the first zoom point when the starting point of the slide gesture is in the first zoom area, and the user interface is zoomed about the second zoom point when the starting point of the slide gesture is in the second zoom area.

17. The electronic device of claim 16, wherein the first zoom point and the second zoom point are defined in two opposite sides of the touch screen.

18. The electronic device of claim 16, wherein the first zoom area and the second zoom area are substantially symmetric.

19. The electronic device of claim 16, wherein the user interface is zoomed out when the starting point is located in the first area and the extending direction of the slide gesture is substantially towards the first zoom point.

20. The electronic device of claim 16, wherein the user interface is zoomed in when the starting point is located in the first area and the extending direction of the slide gesture is substantially away from the first zoom point.
